(19) United States
(12) Patent Application Publication
(10) Pub. No.: US 2025/0305329 A1
(43) Pub. Date: Oct. 2, 2025

(54) Single-bolt lock structure and recreational vehicle lock

(71) Applicant: Shenzhen Hanmai Technology Co., Ltd, Shenzhen (CN)

(72) Inventor: Wenyuan Zhang, Zhangshu (CN)

(21) Appl. No.: 19/238,362

(22) Filed: Jun. 14, 2025

(30) Foreign Application Priority Data
Feb. 28, 2025 (CN) 202510235268.1

(51) Int. Cl. E05B 81/16; E05B 81/06; E05B 81/30; E05B 81/34; E05B 81/82; E05B 83/44

(52) U.S. Cl. CPC E05B 81/16; E05B 81/06; E05B 81/30; E05B 81/34; E05B 81/82; E05B 83/44

(57) ABSTRACT

A single-bolt lock structure and a recreational vehicle lock are provided, which relate to the technical field of locks for vehicles. The single-bolt lock structure includes a lock body. The lock body is provided with a bolt, a locking spring, a door opening handle, and a double-lock mechanism. The locking spring drives the bolt to lock a door. The door opening handle drives the bolt to open the door. The double-lock mechanism performs a limiting and locking operation on the bolt, thus achieving a double-lock effect on the lock body. Since a double-lock base and a locking rod cooperate with a latch bolt, existing problems are solved. By introducing an electrical unlocking mechanism and an electronic module, safety, convenience, and intelligence of the lock are further improved.

### TECHNICAL FIELD

The present disclosure relates to the technical field of locks for vehicles, and in particular, to a single-bolt lock structure and a recreational vehicle lock.

### BACKGROUND

In a traditional lock design, locking and opening of a door are usually implemented by relying on cooperation between a bolt and a door frame bolt slot. The bolt extends outwards under the action of a locking spring and is inserted into the door frame bolt slot to complete a locking operation. To open the door, a door opening handle is turned to drive the bolt to retract into a lock body, and then the bolt is separated from the door frame bolt slot. In order to improve the safety, a double-lock mechanism is further introduced to many locks. Movement of the bolt is limited in a mechanical limiting manner, to ensure that the bolt cannot be driven in a double-lock state even if the door opening handle is turned, so that protection performance of the lock is improved.

However, the double-lock mechanism of a traditional lock has some significant issues. Firstly, the traditional double-lock mechanism usually relies on a “dead bolt” design. This design not only makes the lock have a complex structure, but also takes up a large space and has a low response speed. In practical use, this design easily causes wear or jamming due to long-term use, which affects reliability of the lock. In addition, in a moving occasion such as a vehicle, the direct connection between the bolt and a lock cylinder may cause collision damage to the lock cylinder due to bumps or vibrations. This further affects the service life and safety of the lock.

The Chinese patent document No. CN219241584U discloses a single-bolt lock body with a double-lock function, including a lock case. The lock case is slidably provided with a bolt through a locking rod, and the locking rod is sleeved with a locking spring that drives the bolt to extend out of the lock case. A double-lock member is arranged inside the lock case in a manner of sliding up and down. An actuator that drives the double-lock member to slide upwards is rotatably arranged at a position of the lock case close to an upper end portion of the double-lock member. An unlocking member and a lock cylinder that drives the double-lock member to slide up and down are arranged at positions of the lock case close to a lower end portion of the double-lock member.

Although it is also of a single-bolt structure, the double-lock member of the lock body is arranged on a side surface of a moving position of the locking rod. If the lock body is mounted on a vehicle for use, the bumpy vehicle can easily cause the double-lock member to collide with the locking rod and be damaged. Furthermore, the actuator and the unlocking member have complex structures, and have lifted service lives during the use in the bumpy vehicle.

In summary, in order to improve the safety, reliability, and case of use of the lock and meet needs of different scenarios, for example, for a special place such as a recreational vehicle, an existing lock structure and unlocking mode need to be improved and optimized.

### SUMMARY

In order to overcome the drawbacks described above, the present disclosure aims to provide a technical solution that can solve the above problems.

The present disclosure provides a single-bolt lock structure, including a lock body; a bolt and a locking spring are arranged inside the lock body; the bolt is movably connected to the lock body; two load-bearing ends of the locking spring are respectively abutted against the lock body and the bolt, to drive the bolt to extend outwards by a length through a lock hole provided in one side of the lock body and then be inserted into a door frame bolt slot, thus achieving a locking operation on a door; the lock body is further rotatably connected with a door opening handle; one end of the door opening handle is in transmission connection to the bolt to drive the bolt to move a distance into the lock body and be separated from the door frame bolt slot, thus achieving an opening operation on the door; the lock body is further provided with a double-lock mechanism; and the double-lock mechanism is movably connected to the lock body and performs a limiting and locking operation on the bolt, thus limiting the bolt from moving into the lock body and achieving a double-lock operation on the lock body.

Further, one end of the bolt is set as a latch bolt end for extending out of the lock body and being inserted into the door frame bolt slot; an end portion of another end of the bolt is set as a double-lock end for being abutted against the double-lock mechanism; the double-lock mechanism is provided with a locking rod; and the locking rod is separably abutted against the double-lock end to perform a releasable locking operation on the bolt.

Further, the double-lock mechanism is provided with a double-lock base; one end of the locking rod is fixedly connected to the double-lock base, and another end of the locking rod forms a free end; and the double-lock base is rotatably connected to the lock body and is rotated by an angle under driving of an unlocking device, so as to switch the locking rod between two states of being abutted against the bolt and being separated from the bolt.

Further, a side wall of the free end of the locking rod is separably abutted against the double-lock end of the bolt.

Further, an end portion of the free end of the locking rod is separably abutted against the double-lock end of the bolt.

Further, one end of the door opening handle forms a door handle for opening the door, and an unlocking lever is arranged at another end of the door opening handle; and one end of the unlocking lever is fixedly connected to the door opening handle, and another end of the unlocking lever is in transmission connection to the bolt and is able to drive the bolt to move a distance into the lock body, so that the bolt is released from the door frame bolt slot to achieve the opening operation on the door.

Further, the unlocking device is further provided with an electrical unlocking mechanism; the electrical unlocking mechanism is provided with an unlocking motor and an unlocking gear set; and one end of the unlocking gear set is in transmission connection to an output shaft of the unlocking motor, and another end of the unlocking gear set is in transmission connection to the double-lock base to drive the double-lock base to drive the locking rod to be abutted against or separated from the bolt.

Further, the unlocking gear set is provided with a shaft sleeve gear and a runout gear; the shaft sleeve gear is in transmission connection to the output shaft of the unlocking motor; the runout gear is in transmission connection to the double-lock base; and the shaft sleeve gear cooperates with the runout gear to form separable transmission connection.

Further, active end surface teeth are arranged at one end of the shaft sleeve gear facing the runout gear; passive end surface teeth are arranged at one end of the runout gear facing the shaft sleeve gear; and the active end surface teeth and the passive end surface teeth cooperate with each other to form a separable meshed connection.

A recreational vehicle lock is further provided, including the above single-bolt lock structure and further including an electronic module for controlling the electrical unlocking mechanism to perform an unlocking or locking operation; the electronic module is provided with a battery module, a control module, and a password button that are electrically connected to each other; the battery module is electrically connected to the unlocking motor of the electrical unlocking mechanism; the control module is configured to set and control the recreational vehicle lock; and the password button is configured to input a password.

Compared with the prior art, the present disclosure has the beneficial effects below:

By canceling the traditional “dead bolt” design, a mechanical structure of a lock is optimized in a manner of using the double-lock base and the locking rod to cooperate with a latch bolt. The locking rod is abutted against an end of the locking rod of the latch bolt, thereby blocking a retraction path of the latch bolt and achieving a double-lock operation. When unlocking is required, after the double-lock base is rotated to release the locking rod from the latch bolt, the door opening handle can be used to drive the bolt to retract into the lock body, thus completing the door opening operation.

The locking rod is used to limit the double-lock end of the bolt, so that the releasable locking operation is achieved on the bolt. This simplified the structure, and improves the reliability and safety of the lock. Meanwhile, the separated design of the bolt and the lock cylinder effectively avoids a risk of damage to the lock cylinder due to the collision with the bolt during vehicle operation.

In addition, the present disclosure further introduces the electrical unlocking mechanism and the electronic module. The unlocking motor drives the double-lock base to rotate, thereby implementing automatic unlocking and locking operations on the lock. The electronic module integrates the battery module, the control module, and the password button, so that a user can control opening and closing of the lock through password inputting, which further improves intelligence and convenience of the lock. This design is particularly applicable to a moving occasion such as a recreational vehicle, and can effectively meet multiple needs of modern life for safety, convenience, and durability.

In summary, by optimizing the mechanical structure of the traditional lock and canceling a dead bolt design, a mode in which a double-lock base and a locking rod cooperate with a latch bolt, so that problems that a traditional lock has a complex structure, takes up a large space, has a low response speed, and the like are solved. Meanwhile, by introducing the electrical unlocking mechanism and the electronic module, safety, convenience, and intelligence of the lock are further improved. The single-bolt lock structure is particularly applicable to a moving occasion such as a recreational vehicle and can meet multiple needs of modern life for safety, convenience, and durability.

The additional aspects and advantages of the present disclosure will be set forth in part in the description below, parts of which will become apparent from the description below, or will be understood by the practice of the present disclosure.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of an electronic module and an inner knob according to the present disclosure;

FIG. 2 is a schematic structural diagram of a mechanical lock cylinder and a password button according to the present disclosure;

FIG. 3 is a schematic structural diagram of an abutted state of a double-lock end and a locking rod according to the present disclosure;

FIG. 4 is a schematic structural diagram of a limiting side wall, an unlocking lever, and a passive push block according to the present disclosure;

FIG. 5 is a schematic structural diagram of a separated state of a bolt and a locking rod according to the present disclosure;

FIG. 6 is a schematic structural diagram of a door opening handle that drives a bolt to move, to enter a door opening state according to the present disclosure;

FIG. 7 is a schematic structural diagram of a separated state of an arc-shaped slot and an arc-shaped portion according to the present disclosure;

FIG. 8 is a schematic structural diagram of an unlocking gear set according to the present disclosure;

FIG. 9 is a schematic structural diagram of a separated state of a runout gear and a shaft sleeve gear according to the present disclosure; and

FIG. 10 is a schematic structural diagram of a remote controller according to the present disclosure.

Reference numerals and names in the drawings are as follows:

10: lock body; 11: limiting side wall; 12: locking spring; 13: tactile switch; 14: balance slot; 15: door opening handle; 16: unlocking lever; 17: inner knob; 18: mechanical lock cylinder; 20: bolt; 21: latch bolt end; 22: double-lock end; 23: passive push block; 24: avoiding slot; 25: arc-shaped slot; 30: double-lock mechanism; 31: locking rod; 32: arc-shaped portion; 33: touch bulge; 34: double-lock base; 35: driven tooth; 40: electrical unlocking mechanism; 41: unlocking motor; 50: unlocking gear set; 51: compression spring; 52: shaft sleeve gear; 53: active end surface tooth; 54: center column; 55: runout gear; 56: passive end surface tooth; 57: drive tooth; 58: balance column; 60: electronic module; 61: battery module; 62: charging interface; 63: control module; 64: shortcut button; and 65: password button.

### DETAILED DESCRIPTION OF THE EMBODIMENTS

The technical solutions in the embodiments of the present disclosure are clearly and completely described below. Apparently, the described embodiments are merely some embodiments of the present disclosure, rather than all of the embodiments. All other embodiments obtained by a person of ordinary skill in the art based on the embodiments of present disclosure without making creative efforts shall fall within the protection scope of present disclosure.

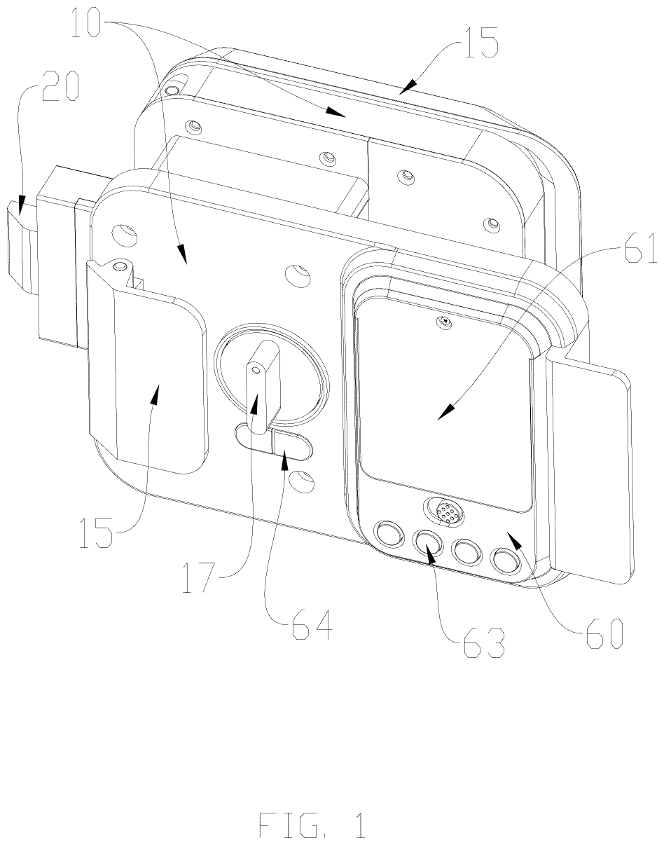

Referring to FIG. 1 to FIG. 9, in this embodiment of the present disclosure, a single-bolt lock structure includes a lock body 10. A bolt 20 and a locking spring 12 are arranged inside the lock body 10. The bolt 20 is movably connected to the lock body 10. Two load-bearing ends of the locking spring 12 are respectively abutted against the lock body 10 and the bolt 20, to drive the bolt 20 to extend outwards by a length through a lock hole provided in one side of the lock body 10 and then be inserted into a door frame bolt slot, thus achieving a locking operation on a door. The lock body 10 is further rotatably connected with a door opening handle 15. One end of the door opening handle 15 is in transmission connection to the bolt 20 to drive the bolt 20 to move a distance into the lock body 10 and be separated from the door frame bolt slot, thus achieving an opening operation on the door. The lock body 10 is further provided with a double-lock mechanism 30. The double-lock mechanism 30 is movably connected to the lock body 10 and performs a limiting and locking operation on the bolt 20, thus limiting the bolt 20 from moving into the lock body 10 and achieving a double-lock operation on the lock body 10.

Specifically, usually, a lock has a bolt 20. When the bolt 20 that extends outwards is inserted into the door frame bolt slot of a door frame, the locking operation on the door is achieved. When the door needs to be opened, the lock body 10 needs to be unlocked first. The door opening handle 15 can be used to drive the bolt 20 to return into the lock body 10, namely, to exit the door frame bolt slot, thereby releasing the locking operation on the door and opening the door. In order to improve the safety, the double-lock mechanism 30 can be provided to lock the bolt 20 twice, so that the door opening handle 15 cannot drive the bolt 20 to move, thereby achieving a double-lock operation on the door. Only by correctly opening the double-lock mechanism 30 to release the restriction on the bolt 20, the lock can be opened by using the door opening handle 15 again, and the corresponding door can be opened.

However, the traditional lock has a complex structure is not considered to be mounted in a vehicle for use. As a result, the bumpy vehicle easily collides with and damages an inner structure of the lock. Especially, side wall adhesion is used between the double-lock mechanism 30 and the bolt 20, so that the shaking bolt 20 may easily collide with the double-lock mechanism 30, and the bolt 20 is easy to damage.

Therefore, the present disclosure cancels a dead bolt and uses the double-lock base 34 and the locking rod 31 to be abutted against a latch bolt. A specific structure is that the locking rod 31 is abutted against an end of the locking rod of the latch bolt, which changes the traditional side surface adhesion structure. The latch bolt is blocked on a retraction path of the latch bolt, so that the latch bolt cannot retract. It achieves the double-lock operation. Even if the vehicle bumps up and down, causing the bolt 20 to shake violently up and down, the locking rod 31 at the end of the bolt cannot be damaged. Moreover, an arc-shaped slot 25 can also be provided in an end portion of the double-lock end 22 of the bolt 20, and an arc-shaped portion 32 can be arranged at a position of the locking rod 31 that is abutted against the arc-shaped slot 25, so that the arc-shaped portion 32 and the arc-shaped slot 25 cooperate with each other to generate a displacement space. Even if the bolt 20 shakes violently, the locking rod 31 will not be damaged, and a locking effect of the locking rod 31 on the bolt 20 can be ensured.

Secondly, when unlocking is required, only after the double-lock base 34 needs to be rotated to cause the locking rod 31 to release the abutment and locking on the latch bolt, the door opening handle 15 can be pulled to perform the door opening operation. Especially by arranging the double-lock base 34, the bolt 20 and a lock cylinder can be separated from each other, to prevent damage to the lock cylinder because the bolt 20 is bumped and collided during vehicle operation.

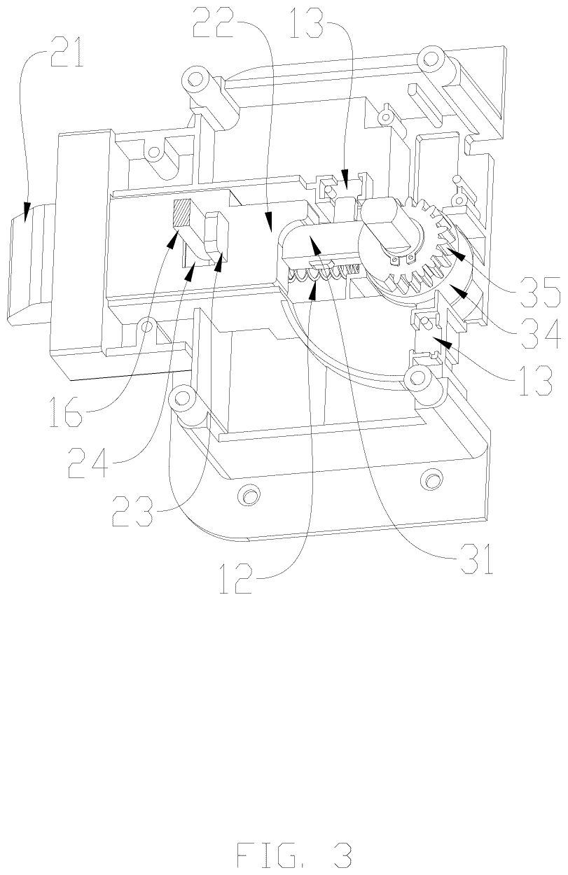

As shown in FIG. 3, preferably, one end of the bolt 20 is set as a latch bolt end 21 for extending out of the lock body 10 and being inserted into the door frame bolt slot. An end portion of another end of the bolt is set as a double-lock end 22 for being abutted against the double-lock mechanism 30. The double-lock mechanism 30 is provided with a locking rod 31. The locking rod 31 is separably abutted against the double-lock end 22 to perform a releasable locking operation on the bolt 20.

Specifically, one end of the bolt 20 is set as the latch bolt end 21 for extending out of the lock body 10 and being inserted into the door frame bolt slot, and the another end of the bolt is set as the double-lock end 22 for being abutted against the double-lock mechanism 30. Through the separable abutment of the double-lock mechanism 30 (including the double-lock base 34 and the locking rod 31), the releasable locking operation is implemented on the bolt 20. Furthermore, the locking rod 31 is abutted against the end portion of the double-lock end 22 of the bolt 20, so even if the bolt 20 shakes up and down during the vehicle operation, the bolt will not collide with the locking rod 31 and will not affect the service life of the locking rod 31.

In particular, in the locking process, an interaction force between the locking rod 31 and the bolt 20 is transmitted in an axial direction of the bolt 20 and is also transmitted in an axial direction of the locking rod 31, so as not to generate a lateral force on the bolt 20 or the locking rod 31, thereby lowering a risk of breakage and prolonging the service life of the bolt 20 or the locking rod 31.

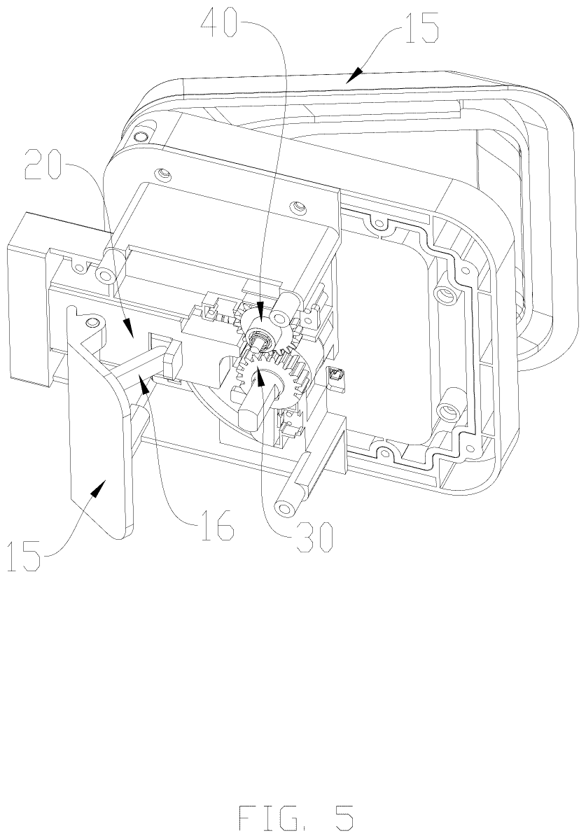

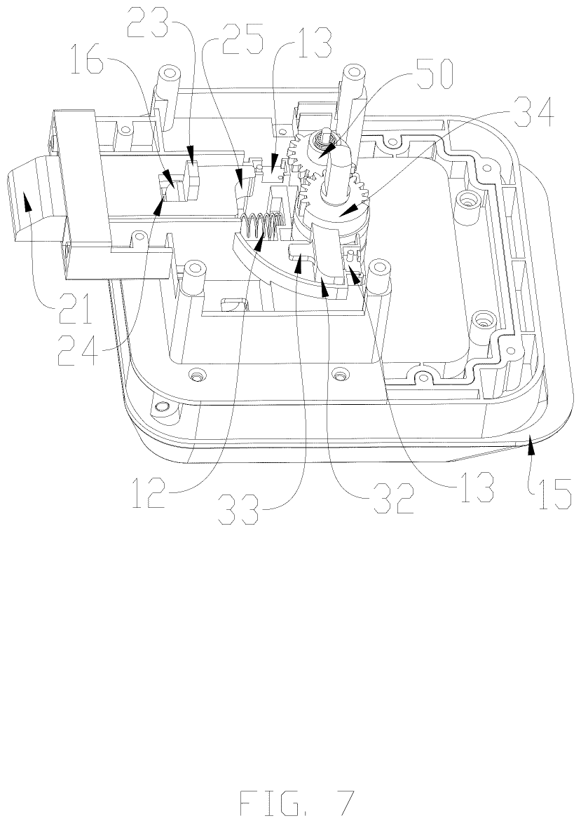

As shown in FIG. 3, FIG. 5 and FIG. 7, preferably, the double-lock mechanism 30 is provided with a double-lock base 34. One end of the locking rod 31 is fixedly connected to the double-lock base 34, and another end of the locking rod 31 forms a free end. The double-lock base 34 is rotatably connected to the lock body 10 and is rotated by an angle under driving of an unlocking device, or the double-lock base 34 is slidably connected to the lock body 10 and slides a distance under the driving of the unlocking device, so as to switch the locking rod 31 between two states of being abutted against the bolt 20 and being separated from the bolt 20.

Specifically, the double-lock base 34 can switch the states of the locking rod 31 by rotating or sliding under the driving of the unlocking device. The rotation or sliding of the double-lock base 34 can drive the locking rod 31 to be abutted against or separated from the double-lock end 22 of the bolt 20, thereby achieving the double-lock and unlocking operations of the lock.

As shown in FIG. 3 and FIG. 5, preferably, a side wall of the free end of the locking rod 31 is separably abutted against the double-lock end 22 of the bolt 20. An end portion of the free end of the locking rod 31 is separably abutted against the double-lock end 22 of the bolt 20.

Specifically, when the double-lock base 34 is arranged in an axial extension direction of the bolt 20, it is preferable to use the end portion of the free end of the locking rod 31 to be abutted against the double-lock end 22. When the double-lock base 34 is arranged in a vertical direction of the axial direction of the bolt 20, it is preferable to use the side wall of the free end of the locking rod 31 to be abutted against the double-lock end 22. Using the side wall to be abutted against the double-lock end 22 can reduce a length of the lock body 10, but it can correspondingly reduce the locking performance of the bolt 20. Therefore, the side wall is only used in a scene in which a requirement is put forward to the length of the lock body 10.

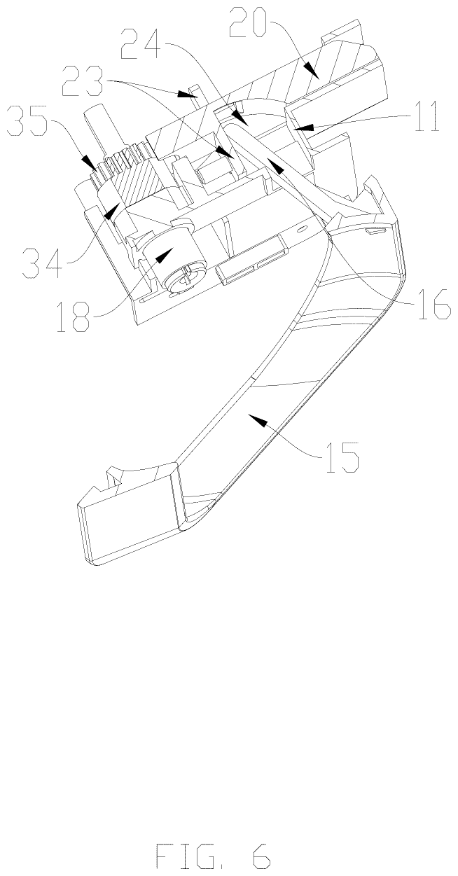

As shown in FIG. 1, FIG. 5, and FIG. 6, preferably, the door opening handle 15 is rotatably connected to the lock body 10. One end of the door opening handle 15 forms a door handle for opening the door, and an unlocking lever 16 is arranged at another end of the door opening handle. One end of the unlocking lever 16 is fixedly connected to the door opening handle 15, and another end of the unlocking lever 16 is in transmission connection to the bolt 20 and is able to drive the bolt 20 to move a distance into the lock body 10, so that the bolt is released from the door frame bolt slot to achieve the opening operation on the door.

Specifically, the bolt 20 is provided with a passive push block 23 at a position corresponding to the unlocking lever 16. The passive push block 23 is fixedly connected to the bolt 20 and is configured to cooperate with the unlocking lever 16 to drive the bolt 20 to return back into the lock body 10, thus achieving an unlocking operation. In addition, an avoidance slot 24 is further provided in a portion of the bolt 20 corresponding to the unlocking lever 16. The avoidance slot 24 is configured to accommodate an end of the unlocking lever 16, so that the unlocking lever 16 cooperates with the bolt 20 to avoid a position conflict.

Secondly, the door opening handle 15 is further provided with an outer handle and an inner handle, both of which are rotatably connected to the lock body 10 and have corresponding unlocking levers 16. A user can move the outer handle outside the door or move the inner handle inside the door. In both manners, the bolt 20 can be pushed back a distance and be separated from the door frame bolt slot, thus achieving the door opening operation.

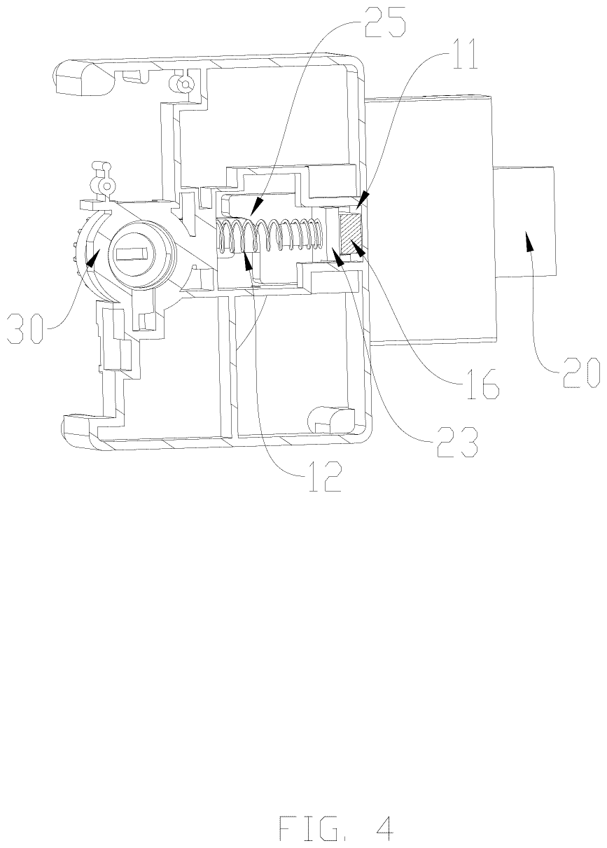

Furthermore, in order to prevent the bolt 20 from extending outwards too long under an elastic force of the locking spring 12, a limiting side wall 11 can also be arranged at a corresponding position of the lock body 10. The limiting side wall 11 can perform a limiting operation on the bolt 20 to make its outward extension length conform to a preset length. For example, a limiting operation of the bolt 20 can be achieved by making the limiting side wall 11 cooperate with the passive push block 23. Furthermore, the unlocking lever 16 also needs to cooperate with the passive push block 23 to achieve the retraction operation on the bolt 20. Therefore, the unlocking lever 16 can be arranged between the limiting side wall 11 and the passive push block 23, as shown in FIG. 4, causing the limiting side wall 11 to achieve the limiting operation on the bolt 20 through the cooperation between the unlocking lever 16 and the passive push block 23, while not hindering the unlocking lever 16 from pushing the passive push block 23. This achieves the retraction operation on the bolt 20.

As shown in FIG. 5 and FIG. 7, preferably, the unlocking device is further provided with an electrical unlocking mechanism 40. The electrical unlocking mechanism 40 is provided with an unlocking motor 41 and an unlocking gear set 50. One end of the unlocking gear set 50 is in transmission connection to an output shaft of the unlocking motor 41, and another end of the unlocking gear set 50 is in transmission connection to the double-lock base 34 to drive the double-lock base 34 to drive the locking rod 31 to be abutted against or separated from the bolt 20.

Specifically, touch bulges 33 are respectively arranged on two sides of the locking rod 31. When the locking rod 31 is in a locked or unlocked state, touch switches 13 are respectively mounted at positions of the touch bulges 33 corresponding to the lock body 10, so that when the double-lock base 34 drives the locking rod 31 for locking or unlocking, the touch bulges 33 can be synchronously abutted against the corresponding touch switches 13, and the touch switches 13 transmit corresponding electrical signals to the control module 63. After receiving the electrical signals, the control module 63 can control the unlocking motor 41 to stop running, thereby further optimizing the safety and reliability of the lock.

Secondly, the unlocking motor 41 drives the unlocking gear set 50 (including a shaft sleeve gear 52 and a runout gear 55), so that the double-lock base 34 is further driven to rotate an angle, thereby achieving the locking or unlocking operation performed by the locking rod 31 on the bolt 20. A separable meshed connection is used between the runout gear 55 and the shaft sleeve gear 52. When the double-lock base 34 is rotated in place, the runout gear 55 can move away from the shaft sleeve gear 52, forming a “gear tooth skipping” state, cutting off a transmission torque, protecting the unlocking gear set 50 and the double-lock base 34, and preventing a danger of tooth breakage caused by an overload.

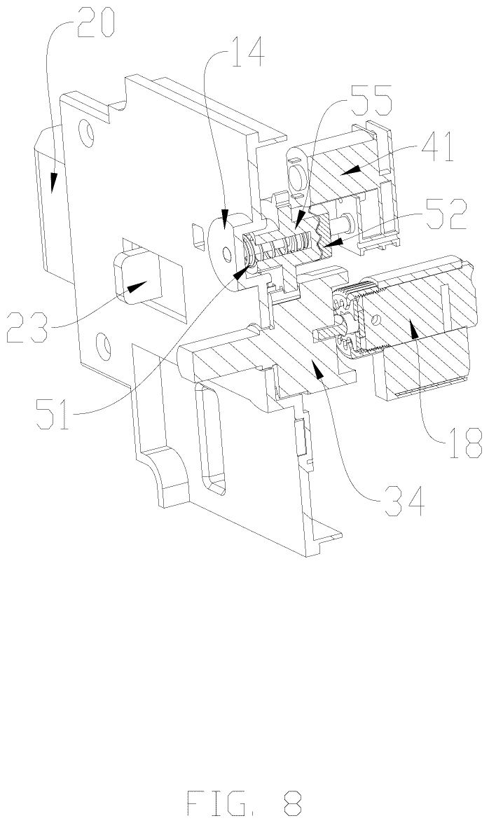

As shown in FIG. 8, preferably, the unlocking gear set 50 is provided with a shaft sleeve gear 52 and a runout gear 55. The shaft sleeve gear 52 is in transmission connection to the output shaft of the unlocking motor 41. The runout gear 55 is in transmission connection to the double-lock base 34. The shaft sleeve gear 52 cooperates with the runout gear 55 to form separable transmission connection.

Specifically, the corresponding transmission connection can be implemented between the shaft sleeve gear 52 and the output shaft of the unlocking motor 41 by button connection, interference fit connection, expansion sleeve connection, or the like in the existing art. Alternatively, the output shaft can be directly set as a D-shaped shaft, and then is matched with a D-shaped hole of the shaft sleeve gear 52. This can effectively prevent a gear from sliding on a shaft and provide a reliable transmission connection.

Secondly, the runout gear 55 is provided with drive teeth 57 at a position corresponding to the double-lock base 34, and the double-lock base 34 is provided with driven teeth 35 at a position corresponding to the drive teeth 57. The drive teeth 57 and the driven teeth 35 are meshed with each other to form a transmission connection, so as to operate the unlocking motor 41, drive the shaft sleeve gear 52 to rotate, and drive the runout gear 55 to rotate. The drive teeth 57 of the runout gear 55 drive the driven teeth 35 of the double-lock base 34 to rotate synchronously, drive the double-lock base 34 to rotate an angle, and drive the locking rod 31 to be abutted against or separated from the bolt 20.

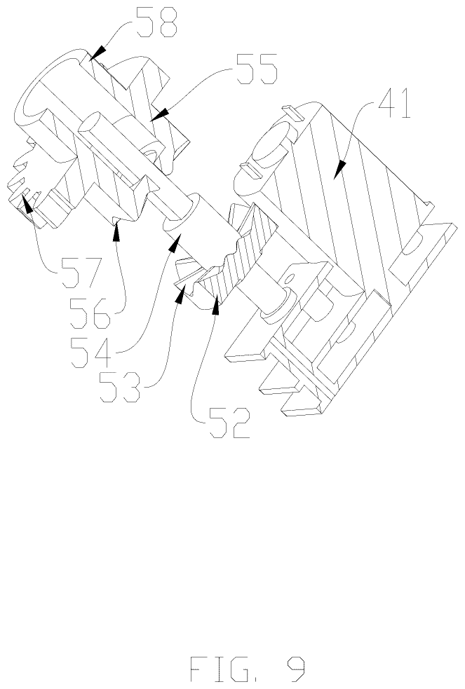

As shown in FIG. 9, preferably, active end surface teeth 53 are arranged at one end of the shaft sleeve gear 52 facing the runout gear 55. Passive end surface teeth 56 are arranged at one end of the runout gear 55 facing the shaft sleeve gear 52. The active end surface teeth 53 and the passive end surface teeth 56 cooperate with each other to form a separable meshed connection.

Specifically, in order to achieve better fitness between the end surface teeth, a relatively long center column 54 can be arranged at the end of the shaft sleeve gear 52 facing the runout gear 55, so that the runout gear 55 can sleeve the center column 54 and rotate around the center column 54.

Secondly, in a normal operation state, the active end surface teeth 53 and the passive end surface teeth 56 are meshed with each other, which can transmit a rotation torque normally, causing the unlocking motor 41 to drive the double-lock base 34 to rotate, thereby achieving the locking or unlocking operation. When the double-lock base 34 is rotated to an angle and cannot continue to be rotated, the touch bulges 33 are exactly abutted against the touch switches 13, causing the touch switches 13 to transmit the electrical signals to the control module 63, and the control module 63 controls the unlocking motor 41 to stop running. However, when the touch switches 13 are damaged or when the unlocking motor 41 does not stop in time, the shaft sleeve gear 52 may also continue to be driven to rotate. In this case, a tooth surface of the active end surface teeth 53 and a tooth surface of the passive end surface teeth 56 cooperate with each other, thus generating a pushing force in an axial direction of the runout gear 55. The runout gear 55 moves away from the shaft sleeve gear 52, and the active end surface teeth 53 and the passive end surface teeth 56 are separated from each other to form the gear tooth skipping state, thereby cutting off a transmission torque between the shaft sleeve gear 52 and the runout gear 55, protecting the unlocking gear set 50 and the double-lock base 34, and preventing the danger of tooth breakage.

Furthermore, when an inner knob 17 or a mechanical lock cylinder 18 is used to unlock or lock a recreational vehicle lock, turning the lock cylinder can drive the double-lock base 34 to lock or release the bolt 20, thus achieving the locking or unlocking operation. In this case, the double-lock base 34 can also drive the runout gear 55 to rotate synchronously. Since the shaft sleeve gear 52 is in a stationary state at this time, the runout gear 55 can also be driven by the double-lock base 34 to separate the passive end surface teeth 56 from the active end surface teeth 53, to allow the runout gear 55 to rotate normally.

In addition, when the runout gear 55 moves a distance away from the shaft sleeve gear 52, a pressure can be applied to a compression spring 51, causing the compression spring to deform. When the rotation of the shaft sleeve gear 52 or the double-lock base 34 stops, the compression spring 51 is reset, and the runout gear 55 is pushed towards the shaft sleeve gear 52 again, so that the active end surface teeth 53 and the passive end surface teeth 56 are abutted against each other and are meshed again to form the transmission connection.

As shown in FIG. 8, preferably, the unlocking gear set 50 is further provided with a compression spring 51. One end of the compression spring 51 is abutted against the lock body 10, and another end of the compression spring 51 is abutted against the runout gear 55, so that an elastic force of the compression spring drives the runout gear 55 to move towards the shaft sleeve gear 52, thereby causing the passive end surface teeth 56 and the active end surface teeth 53 to be abutted against each other to form a separable meshed connection.

Specifically, since the elastic force of the compression spring 51 drives the runout gear 55 to move towards the shaft sleeve gear 52, the active end surface teeth 53 of the runout gear 55 and the passive end surface teeth 56 of the shaft sleeve gear 52 form the separable meshed connection, which ensures efficient operation of the unlocking mechanism.

In addition, in order to make the rotation of the runout gear 55 smoother, a balance column 58 can be arranged at one end of the runout gear 55 away from the shaft sleeve gear 52, and a balance slot 14 can be provided in a position of the lock body 10 corresponding to the balance column 58, so that the balance column 58 of the runout gear 55 can pass through the balance slot 14 and jump in the axial direction of the runout gear 55, to generate a displacement change, implement separation between the shaft sleeve gear 52 and the runout gear 55, and release the transmission connection between them.

Secondly, a countersunk hole is further provided in a center axis of the balance column 58, so that the compression spring 51 can be inserted into the countersunk hole. One end of the compression spring 51 can be abutted against the runout gear 55, and another end can be abutted against a bottom wall of the balance slot 14. In order to optimize the cooperation between the output shaft of the unlocking motor 41 and the unlocking gear set 50, a shaft hole can be provided in the bottom wall of the balance slot 14, so that the free end of the output shaft can be inserted into the shaft hole to form a rotatable connection and avoid shaking of the free end of the output shaft.

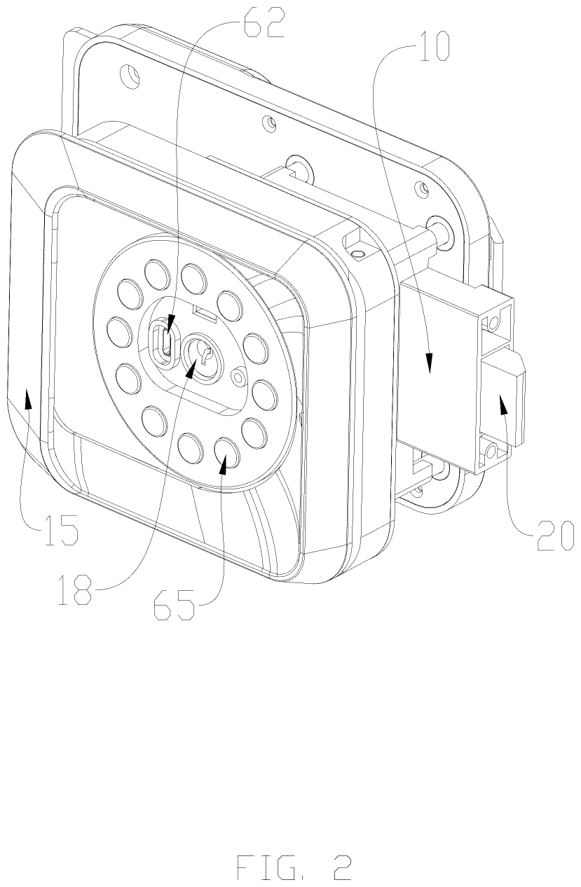

As shown in FIG. 1 and FIG. 2, preferably, the present disclosure further provides a recreational vehicle lock, including the above lock structure and further including an electronic module 60 for controlling the electrical unlocking mechanism 40 to perform an unlocking or locking operation. The electronic module 60 is provided with a battery module 61, a control module 63, and a password button 65 that are electrically connected to each other. The battery module 61 is electrically connected to the unlocking motor 41 of the electrical unlocking mechanism 40. The control module 63 is configured to set and control the recreational vehicle lock. The password button 65 is configured to input a password.

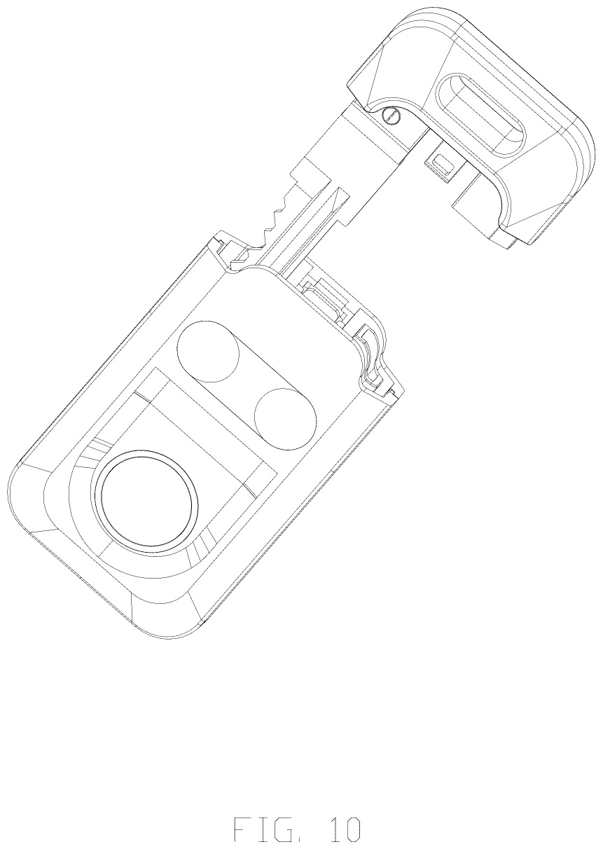

Specifically, the control module 63 can perform operations such as setting, modifying, and clearing an unlocking password, and the password button 65 is configured to input corresponding password numbers or characters during setting of a password or during unlocking. The control module 63 is further provided with a remote control chip (not shown in the figure), so that the corresponding locking or unlocking operation can be performed through a remote controller. Moreover, as shown in FIG. 10, a mechanical key can be stored in the remote controller for easy carrying.

Secondly, the control module 63 and the battery module 61 are arranged on one side of the recreational vehicle lock facing inwards, and the password button 65 is arranged on one side of the recreational vehicle lock facing outwards. When a user needs to unlock the lock outside the door, the user can input the corresponding password. A quick locking button can also be arranged on the password button 65, which means that after the user closes the door, the user can directly use the quick locking button to lock the recreational vehicle lock, without inputting the password.

Furthermore, the control module 63 is further provided with a shortcut button 64. The shortcut button 64 is electrically connected to the control module 63 and the electrical unlocking mechanism 40 respectively. The shortcut button 64 is preferably arranged on the side of the recreational vehicle lock facing inwards, so that the user can implement a one-key locking or unlocking operation inside the door. The battery module 61 is further provided with a charging interface 62. The charging interface 62 is arranged on the side of the recreational vehicle lock facing outwards, to replenish electrical energy to the battery module 61.

In addition, the unlocking device is provided with an inner knob 17. The inner knob 17 is rotatably connected to one side of the lock body 10 facing inwards, and is in transmission connection to the double-lock base 34 to drive the double-lock base 34 to drive the locking rod 31 to be abutted against or separated from the bolt 20. The unlocking device is further provided with an inner slider. The inner slider is rotatably connected to the side of the lock body 10 facing inwards, and is in transmission connection to the double-lock base 34 to drive the double-lock base 34 to drive the locking rod 31 to be abutted against or separated from the bolt 20.

As shown in FIG. 2 and FIG. 6, the unlocking device is further provided with a mechanical lock cylinder 18. The mechanical lock cylinder 18 is mounted on one side of the lock body 10 facing outwards. A lever of the mechanical lock cylinder 18 is in transmission connection to the double-lock base 34 to drive the double-lock base 34 to drive the locking rod 31 to be abutted against or separated from the bolt 20. Specifically, when the battery module runs out of power or the electronic module 60 is faulty, a key can also be used to perform the unlocking and locking operations on the mechanical lock cylinder 18 to further improve applicability of the lock.

### Embodiment I: Basic Single-Bolt Lock Structure and Manual Operation

### Basic Lock Structure

The single-bolt lock structure in this embodiment includes a lock body 10. A bolt 20 and a locking spring 12 are arranged inside the lock body 10. The bolt 20 is movably connected to the lock body 10, and two load-bearing ends of the locking spring 12 are respectively abutted against the lock body 10 and the bolt 20. A lock hole is provided in one side of the lock body 10. Under the action of the locking spring 12, the bolt 20 extends outwards by a length through the lock hole and can be inserted into a door frame bolt slot, to achieve a locking operation on a door.

The lock body 10 is further rotatably connected to a door opening handle 15, and one end of the door opening handle 15 is in transmission connection to the bolt 20. When the door needs to be opened, the door opening handle 15 is turned, and an unlocking lever 16 at another end of the door opening handle 15 can drive the bolt 20 to move a distance into the lock body 10, so that the bolt 20 is separated from a door frame bolt slot, thereby achieving an opening operation on the door.

### Double-Lock Mechanism 30 and Manual Operation

The lock body 10 is provided with a double-lock mechanism 30, and the double-lock mechanism 30 includes a double-lock base 34 and a locking rod 31. One end of the locking rod 31 is fixedly connected to the double-lock base 34, and another end forms a free end.

When the door needs to be double-locked, an inner knob 17 is manually turned to cause the double-lock base 34 to rotate synchronously, so that the free end of the locking rod 31 is abutted against a double-lock end 22 of the bolt 20, to block the bolt 20 in a retraction path of a latch bolt and prevent the bolt 20 from retracting, thus achieving a double-lock operation. In this case, even if the door opening handle 15 is turned, the bolt 20 cannot move into the lock body 10 because it is limited by the locking rod 31, and the door cannot be opened.

When unlocking is required, the inner knob 17 is manually turned again to separate the locking rod 31 from the double-lock end 22 of the bolt 20, thus releasing the restriction on the bolt 20. In this case, the door opening handle 15 can be pulled to perform a door opening operation.

### Embodiment II: Electrical Unlocking of Single-Bolt Lock

### Constitutions of Electrical Unlocking Mechanism 40

The lock in this embodiment is additionally provided with an electrical unlocking mechanism 40 based on Embodiment I. The electrical unlocking mechanism 40 is provided with an unlocking motor 41 and an unlocking gear set 50. The unlocking gear set 50 includes a shaft sleeve gear 52, a runout gear 55, and a compression spring 51. The shaft sleeve gear 52 is in transmission connection to an output shaft of the unlocking motor 41. The runout gear 55 is in transmission connection to the double-lock base 34. The shaft sleeve gear 52 cooperates with the runout gear 55 through active end surface teeth 53 and passive end surface teeth 56, to form separable transmission connection. One end of the compression spring 51 is abutted against the lock body 10, and another end of the compression spring 51 is abutted against the runout gear 55, so that an elastic force of the compression spring drives the runout gear 55 to move towards the shaft sleeve gear 52, thereby causing the passive end surface teeth 56 and the active end surface teeth 53 to be abutted against each other to form a separable meshed connection.

### Electrical Unlocking Process

When an electrical unlocking or locking operation is required, an electronic module 60 works. The electronic module 60 includes a battery module 61, a control module 63, and a password button 65 that are electrically connected to each other. A user inputs a correct password through the password button 65. After receiving a signal, the control module 63 controls the battery module 61 to supply power to the unlocking motor 41 of the electrical unlocking mechanism 40, and the unlocking motor 41 starts to operate.

The unlocking motor 41 drives the shaft sleeve gear 52 to rotate, and the active end surface teeth 53 of the shaft sleeve gear 52 are meshed with the passive end surface teeth 56 of the runout gear 55, thus driving the runout gear 55 to rotate. The runout gear 55 is provided with drive teeth 57 at a position corresponding to the double-lock base 34, and the double-lock base 34 is provided with driven teeth 35 at a position corresponding to the drive teeth 57. The drive teeth 57 and the driven teeth 35 are meshed with each other, so that the runout gear 55 drives the double-lock base 34 to rotate an angle.

If it is an unlocking operation, the rotation of the double-lock base 34 can release the locking rod 31 from the abutment against the double-lock end 22 of the bolt 20. In this case, the door opening handle 15 can be turned to open the door. If it is a locking operation, the double-lock base 34 is rotated to make the locking rod 31 abutted against the double-lock end 22 of the bolt 20 to achieve locking.

### Protection Mechanism

Touch switches 13 are mounted at corresponding positions of the lock body 10 to detect a state of the locking rod 31. When the locking rod 31 is rotated in place, touch bulges 33 are abutted against the touch switches 13, and the touch switches 13 transmit an electrical signal to the control module 63. The control module 63 then controls the unlocking motor 41 to stop running, to avoid excessive rotation.

If the touch switches 13 are damaged or when the unlocking motor 41 does not stop in time, the shaft sleeve gear 52 continues to be driven to rotate. A tooth surface of the active end surface teeth 53 and a tooth surface of the passive end surface teeth 56 cooperate with each other, thus generating a pushing force in an axial direction of the runout gear 55. The runout gear 55 moves away from the shaft sleeve gear 52, and the active end surface teeth 53 and the passive end surface teeth 56 are separated from each other to form the gear tooth skipping state, thereby cutting off a transmission torque between the shaft sleeve gear 52 and the runout gear 55, protecting the unlocking gear set 50 and the double-lock base 34, and preventing the danger of tooth breakage. When the rotation of the shaft sleeve gear 52 or the double-lock base 34 stops, the compression spring 51 is reset, and the runout gear 55 is pushed towards the shaft sleeve gear 52 again, so that the active end surface teeth 53 and the passive end surface teeth 56 are abutted against each other and are meshed again to form the transmission connection.

A user inputs a password through the password button 65. The control module 63 drives the unlocking motor 41 to operate after verification on the password succeeds, thus driving the unlocking gear set 50 to drive the reverse double-lock base 34, and driving the locking rod 31 to switch states. The unlocking or locking operation is completed. When the double-lock base 34 is rotated in place, the touch switches 13 transmit the electrical signal to the control module 63, and the control module 63 controls the unlocking motor 41 to stop running. If the touch switches 13 are damaged or the unlocking motor 41 does not stop in time, a jumping protection mechanism is activated, to cut off a transmission torque and protect the lock structure.

### Embodiment III: Various Unlocking Modes for a Recreational Vehicle Lock

### Overall Structure of the Recreational Vehicle Lock

This embodiment provides a recreational lock that uses the above single-bolt lock structure and that is additionally provided with an electronic module 60 to control the electrical unlocking mechanism 40 to perform an unlocking or locking operation. The electronic module 60 includes a battery module 61, a control module 63, and a password button 65 that are electrically connected to each other. The battery module 61 supplies power to the entire electronic control module 63 and is electrically connected to the unlocking motor 41, thus supplying power to the electrical unlocking mechanism 40. The control module 63 is configured to: set and control the lock, receive an electrical signal from the password button 65, a control button, or the touch switches 13, and control an operation state of the unlocking motor 41 according to a preset logic.

The password button 65 is configured to input a password. After a user inputs a correct password, the control module 63 verifies the password and transmits an instruction to drive the unlocking motor 41 to operate. The unlocking or locking operation is completed.

### Various Unlocking Modes

Electrical password unlocking: A user inputs a correct password through the password button 65 outside a recreational vehicle. After receiving a signal, the control module 63 controls the unlocking motor 41 to operate. According to the electrical unlocking process in Embodiment II, the double-lock base 34 is driven to drive the locking rod 31 to be separated from the bolt 20, thus achieving the unlocking operation.

Unlocking based on an inner knob 17: The unlocking device is provided with the inner knob 17. The inner knob 17 is rotatably connected to one side of the lock body 10 facing inwards and is in transmission connection to the double-lock base 34. In the recreational vehicle, the user can turn the inner knob 17 to actuate the double-lock base 34 to drive the locking rod 31 to be abutted against or separated from the bolt 20, thus achieving the unlocking or locking operation.

Unlocking based on a mechanical lock cylinder 18: The unlocking device is further provided with the mechanical lock cylinder 18. The mechanical lock cylinder 18 is mounted on one side of the lock body 10 facing outwards. A lever of the mechanical lock cylinder 18 is in transmission connection to the double-lock base 34. Outside the vehicle, a user inserts a corresponding mechanical key into the mechanical lock cylinder 18 and turns the key. The lever of the mechanical lock cylinder 18 drives the double-lock base 34 to rotate, so that the locking rod 31 is abutted against or separated from the bolt 20. The unlocking or locking operation is completed.

A high-safety, high-reliability, and convenient lock solution is implemented by optimizing a mechanical design, introducing the electronic control module 63 and a gear tooth skipping protection mechanism, so that the lock solution is especially suitable for a moving occasion such as a recreational vehicle.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure.

What is claimed is:

1. A single-bolt lock structure, comprising a lock body (10), wherein a bolt (20) and a locking spring (12) are arranged inside the lock body (10); the bolt (20) is movably connected to the lock body (10); two load-bearing ends of the locking spring (12) are respectively abutted against the lock body (10) and the bolt (20), to drive the bolt (20) to extend outwards by a length through a lock hole provided in one side of the lock body (10) and then be inserted into a door frame bolt slot, thus achieving a locking operation on a door; the lock body (10) is further rotatably connected with a door opening handle (15); one end of the door opening handle (15) is in transmission connection to the bolt (20) to drive the bolt (20) to move a distance into the lock body (10) and be separated from the door frame bolt slot, thus achieving an opening operation on the door; the lock body (10) is further provided with a double-lock mechanism (30); and the double-lock mechanism (30) is movably connected to the lock body (10) and performs a limiting and locking operation on the bolt (20), thus limiting the bolt (20) from moving into the lock body (10) and achieving a double-lock operation on the lock body (10).

2. The single-bolt lock structure according to claim 1, wherein one end of the bolt (20) is set as a latch bolt end (21) for extending out of the lock body (10) and being inserted into the door frame bolt slot; an end portion of another end of the bolt (20) is set as a double-lock end (22) for being abutted against the double-lock mechanism (30); the double-lock mechanism (30) is provided with a locking rod (31); and the locking rod (31) is separably abutted against the double-lock end (22) to perform a releasable locking operation on the bolt (20).

3. The single-bolt lock structure according to claim 2, wherein the double-lock mechanism (30) is provided with a double-lock base (34); one end of the locking rod (31) is fixedly connected to the double-lock base (34), and another end of the locking rod (31) forms a free end; and the double-lock base (34) is rotatably connected to the lock body (10) and is rotated by an angle under driving of an unlocking device, so as to switch the locking rod (31) between two states of being abutted against the bolt (20) and being separated from the bolt (20).

4. The single-bolt lock structure according to claim 3, wherein a side wall of the free end of the locking rod (31) is separably abutted against the double-lock end (22) of the bolt (20).

5. The single-bolt lock structure according to claim 3, wherein an end portion of the free end of the locking rod (31) is separably abutted against the double-lock end (22) of the bolt (20).

6. The single-bolt lock structure according to claim 1, wherein one end of the door opening handle (15) forms a door handle for opening the door, and an unlocking lever (16) is arranged at another end of the door opening handle (15); and one end of the unlocking lever (16) is fixedly connected to the door opening handle (15), and another end of the unlocking lever (16) is in transmission connection to the bolt (20) and is able to drive the bolt (20) to move a distance into the lock body (10), so that the bolt is released from the door frame bolt slot to achieve the opening operation on the door.

7. The single-bolt lock structure according to claim 3, wherein the unlocking device is further provided with an electrical unlocking mechanism (40); the electrical unlocking mechanism (40) is provided with an unlocking motor (41) and an unlocking gear set (50); and one end of the unlocking gear set (50) is in transmission connection to an output shaft of the unlocking motor (41), and another end of the unlocking gear set (50) is in transmission connection to the double-lock base (34) to drive the double-lock base (34) to drive the locking rod (31) to be abutted against or separated from the bolt (20).

8. The single-bolt lock structure according to claim 7, wherein the unlocking gear set (50) is provided with a shaft sleeve gear (52) and a runout gear (55); the shaft sleeve gear (52) is in transmission connection to the output shaft of the unlocking motor (41); the runout gear (55) is in transmission connection to the double-lock base (34); and the shaft sleeve gear (52) cooperates with the runout gear (55) to form separable transmission connection.

9. The single-bolt lock structure according to claim 8, wherein active end surface teeth (53) are arranged at one end of the shaft sleeve gear (52) facing the runout gear (55); passive end surface teeth (56) are arranged at one end of the runout gear (55) facing the shaft sleeve gear (52); and the active end surface teeth (53) and the passive end surface teeth (56) cooperate with each other to form a separable meshed connection.

10. A recreational vehicle lock, comprising the single-bolt lock structure according to claim 1, and further comprising an electronic module (60) for controlling the electrical unlocking mechanism (40) to perform an unlocking or locking operation; the electronic module (60) is provided with a battery module (61), a control module (63), and a password button (65) that are electrically connected to each other; the battery module (61) is electrically connected to the unlocking motor (41) of the electrical unlocking mechanism (40); the control module (63) is configured to set and control the recreational vehicle lock; and the password button (65) is configured to input a password.
